(19) United States
(12) Patent Application Publication
(10) Pub. No.: US 2019/0366255 A1
(43) Pub. Date: Dec. 5, 2019

(54) FILTER CONFIGURATION

(71) Applicant: FAIST Anlagenbau GmbH, Krumbach (DE)

(72) Inventor: Jan SCHLENKERMANN, Bremen (DE)

(73) Assignee: FAIST Anlagenbau GmbH, Krumbach (DE)

(21) Appl. No.: 16/427,530

(22) Filed: May 31, 2019

(30) Foreign Application Priority Data
Jun. 1, 2018 (DE) 10 2018 113 131.3

(51) Int. Cl. B01D 46/24; B01D 46/00

(52) U.S. Cl. CPC B01D 46/2411; B01D 46/0068

(57) ABSTRACT

A filter configuration for gaseous media includes a plurality of structurally identical cylindrical filters, each having a central axis and an open base. A pipe is disposed opposite to the open bases of the filters and has a group of lateral openings dedicated to each filter, through which piped gas can flow in a direction of flow. The manufacture of filter configurations of this type can be expensive, and their cleaning efficiency can be unsatisfactory. To address these issues, each group has a minimum of three openings and the distance between the openings of each group farthest apart from each other in the direction of flow measures at least three times the distance between the openings of each group farthest apart from each other at right angles relative to the direction of flow, as measured around the circumference of the pipe.

### FIELD OF THE DISCLOSURE

The present disclosure relates to a filter configuration for gaseous media according to the preamble of Claim 1.

### BACKGROUND

Generically related perforated pipe nozzle configurations are used for cleaning air filters and filters for gaseous media. In a variety of industrial applications, e.g., in turbines or generators, air is supplied from the outside, which ambient air is frequently highly contaminated, especially in industrial areas or areas having a low atmospheric humidity and in areas having a high sand content. For this reason, the air inlets of air supply plants housing industrial equipment are fitted with filters that, depending on the environmental conditions and the degree of contamination of the air drawn in, clog at different rates and must be cleaned. Cleaning is done by blowing a compressed gas in a series of high-speed on and off pulses from a perforated pipe nozzle onto the filter material on the clean room side of the filter (i.e., in the direction of flow with the air downstream of the filter) in order to build up excess pressure inside the filter relative to the environment, which causes the gas to flow through the filter against the usual direction of flow, thereby causing contaminants on the inside or on the outside of the filter to be dislodged and to fall off. This pulsed flow must occur at regular intervals, with the time between two pulses depending on the degree of contamination of the ambient air. By default and according to the so-called Aramco test, the filters are cleaned at intervals of 20 minutes.

As a rule, in conventional filtering plants, a plurality of cylindrical filters are disposed side by side or according to a type of matrix, and disposed opposite to each row of filters is a perforated pipe nozzle consisting of a pipe having configurations of nozzles along the side, which nozzles are directed into the inside of the cylindrical filter, said filter being open toward the pipe, and able to exert the compressed gas pulse, thereby causing the contaminants on the oppositely lying inlet side to be dislodged from the outside of the cylindrical filters and to be discharged into the region of the base.

In this context, any reference to cylindrical filters in the current claims and in the current description is intended to also include conical filters and filters having a conical [portion] and a cylindrical portion.

In conventional prior-art plants, the perforated pipe nozzle in the area of each filter comprises a nozzle insert that can be screwed, e.g., into the wall of the pipe and that has a plurality of individual nozzles, e.g., up to twelve individual nozzles that are arranged in a circular shape. This type of construction is expensive because it requires an additional structural component for each filter, i.e., a nozzle insert that has to be separately manufactured and screwed into the pipe. In addition, the cleaning efficiency is unsatisfactory because the pressure drop in the pipe from the infeed point to the closed end of the pipe cannot be sufficiently factored in.

U.S. Pat. No. 5,361,452 describes a perforated pipe nozzle without additional nozzle inserts, i.e., in which the pipe only has lateral openings that are disposed opposite to the filters to be cleaned. This nozzle, however, is intended to be centrally inserted along the central axis of a cylindrical filter. Cleaning a plurality of filters that are disposed side by side by positioning the perforated pipe nozzle opposite to them is not provided for.

Other perforated pipe nozzles of similar construction are the subject matter of U.S. Pat. No. 3,912,173 and of JP 5067514 B1.

The subject matter of DE 10 2015 005 414 A1 relates to a configuration for cleaning a filter cartridge and nozzle unit, which configuration comprises one or a plurality of recesses, the overall cross-sectional area of which recesses, across which compressed air can flow, is in a range from 10 mm² to 380 mm², with the recess or the recesses generating a free jet of compressed air that diverges from a free jet generated by a single circular recess.

The subject matter of JP 7016413 A2 relates to a perforated pipe nozzle configuration in which the perforated pipe nozzle is positioned opposite to the inlets of adjacent cylindrical filter configurations and that comprises groups of openings, with each group of openings being positioned opposite to a cylindrical filter to be cleaned. The number of openings in a group, as well as the cross-section of these openings, decreases from the point of application of compressed air to the perforated pipe nozzle.

### SUMMARY

One aspect of the disclosure relates to a filter configuration so that optimum cleaning of each filter within a linear filter configuration can be achieved without requiring additional structural work.

Exemplary embodiments are also disclosed.

The subject matter of the present disclosure relates especially to a filter configuration for gaseous media, comprising a plurality of structurally identical cylindrical filters, each having a central axis and an open base, and a pipe disposed opposite to the open bases of the filters and comprising a group of lateral openings dedicated to each filter, through which pipe gas can flow in a direction of flow. According to the present disclosure, each group comprises at least three openings, and the distance between the openings of each group farthest apart from each other in the direction of flow measures at least three times the distance between the openings of each group farthest apart from each other at right angles relative to the direction of flow, as measured around the circumference of the pipe.

The extension of each group along the pipe preferably covers a minimum of 40% of a diameter of the dedicated filter.

The sum of the cross-sectional areas of all openings within each group has the same value with a tolerance of ±20%.

Each group preferably has the same number of openings, with a possible exception of one opening, and the number of openings of each group is between three and nine, preferably five or six.

In a preferred embodiment, the openings have a diameter between 4 mm and 20 mm, preferably between 8 mm and 18 mm.

The central point of each group of openings is preferably at a distance from the central axis of the filter dedicated thereto, with the openings of the groups, in relation to the central axis of the filter dedicated thereto, being disposed upstream. Thus, the distance from the entry of the compressed air into the pipe decreases in the direction of flow for each group of openings.

The openings preferably have a circular or oval shape. According to an especially preferred embodiment, at least one opening of each group comprises an additionally incorporated pipe-like structure.

With respect to the configuration of the openings within the group and/or the angle of their axes of flow, different groups of openings can have different layouts.

Each opening preferably has an axis of flow extending in the center thereof, and at least one axis of flow of an opening forms an acute angle relative to the central axis of the dedicated filter.

One other axis of flow of at least one other opening of the same group preferably forms another angle relative to the central axis of the dedicated filter, which angle differs from the acute angle of the first opening.

According to a preferred modification of the present disclosure, other axes of flow of other openings of the same group form different acute angles relative to the central axis of the dedicated filter.

### BRIEF DESCRIPTION OF THE DRAWINGS

A few practical examples of the disclosure will be explained in greater detail below with reference to the appended drawings. These drawing show:

FIG. 1 a lateral view of a perforated pipe nozzle according to the present disclosure;

FIG. 2 a front view of the perforated pipe nozzle shown in FIG. 1 after a 90° rotation about the longitudinal direction 4 of the pipe 1;

FIG. 3 a detail view of the detail A of FIG. 2;

FIG. 4 a schematic representation of the distribution of the compressed air exiting from the openings of the pipe across the base of the filter in a practical example with three openings;

FIG. 5 a representation as in FIG. 4 in a practical example with four openings;

FIG. 6 a representation as in FIGS. 4 and 5 in a practical example with five openings;

FIG. 7 a representation as in FIGS. 4 to 6 in a practical example with six openings;

FIG. 8 a highly magnified section through a lateral wall of the pipe 1 in a special practical example of the disclosure;

FIG. 9 a highly magnified section through a lateral wall of the pipe 1 in a second special practical example of the disclosure;

FIG. 10 a lateral view of a filter with an oppositely disposed pipe;

FIG. 11 a representation as in FIG. 10, rotated by 90° relative to the central axis 7;

FIG. 12 a schematic representation of a portion of the perforated pipe nozzle as in FIGS. 1 and 2 in the installed state opposite to a configuration of filters.

### DETAILED DESCRIPTION

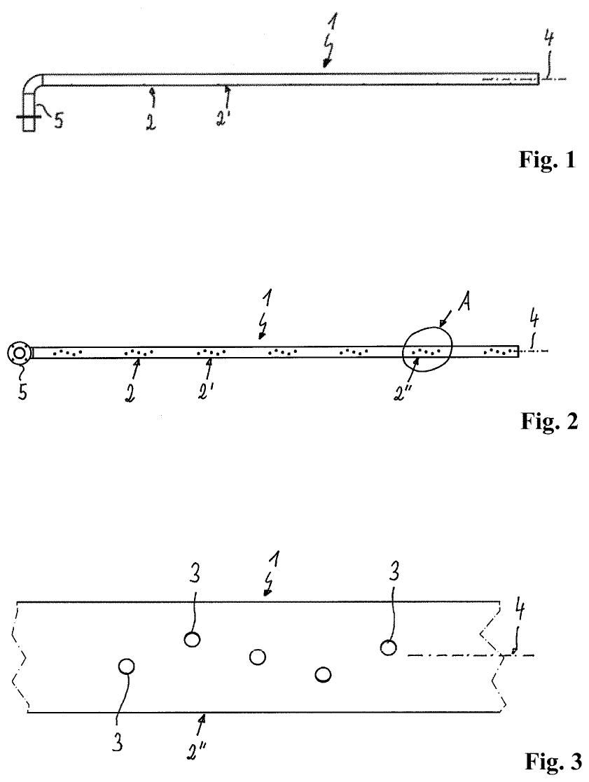

FIGS. 1-3 show a perforated pipe nozzle used to implement the disclosure, which perforated pipe nozzle, up to this point as known in the art, consists of a pipe 1 made of metal, which pipe, on one side (in FIGS. 1 and 2 on the left), has a bend with a point of application 5, via which compressed air or a series of on and off pulses of compressed air jets can be applied to the pipe 1. The other end of the pipe 1 (in the drawings on the right) is closed. The reference numeral 4 identifies the longitudinal direction of the pipe 1.

As especially clearly indicated in FIG. 1 and in the detail view shown in FIG. 3, the pipe 1 has a plurality of groups 2 of lateral openings 3. In the practical example shown, the pipe has seven groups 2, 2′, 2″. Each of these groups 2, 2′, 2″ has five openings 3 that are preferably implemented as bores in the wall of the pipe 1 and that, as especially clearly indicated in FIG. 3, are disposed in a characteristic way, in this case having a profile that resembles that of a sinus curve, with other profiles being possible as well. Taking into account the curvature of the wall of the pipe 1, this configuration of five openings within the group 2″ approximately conforms to the configuration of the spots on the side of a die marked with the number “5”. All openings 3 within all groups 2, 2′, 2″ have approximately the same cross-section, with variances up to a tolerance limit of +/−20% being possible. In addition, each group 2, 2′, 2″ of openings 3 has the same number of openings 3, in the practical example shown, five openings 3 per group 2, 2′ and 2″.

As FIGS. 2 and 3 and especially FIG. 3 indicate, each group has at least three openings, in the practical example shown, five openings, and the distance between the openings of each group 2″ farthest apart from each other in the direction of flow L measures at least three times the distance between the openings 3 of each group 2″ farthest apart from each other at right angles relative to the direction of flow L, as measured around the circumference of the pipe 1. “Distance” is here defined to mean the entire extension of the group 2″ in the direction of flow L and at right angles relative to the direction of flow L, which means that the diameter of the openings 3 is included in the distance.

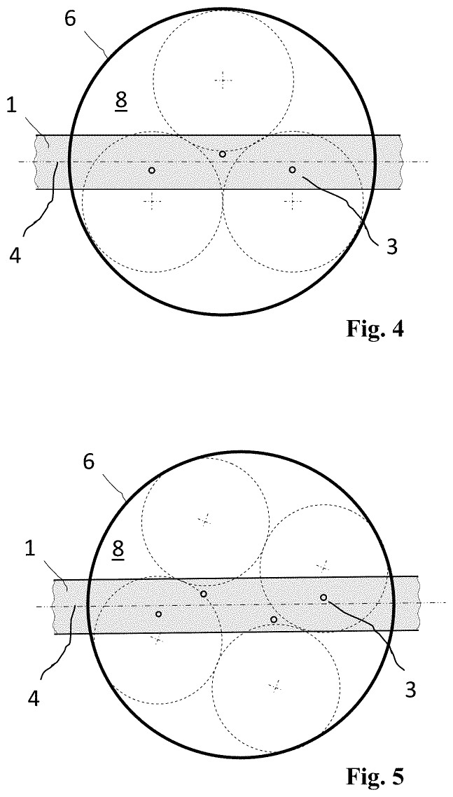

FIGS. 4-7 show a schematic representation of the flow profile and the effect of different configurations of openings 3 in the wall of the pipe 4 on the open base 8 of the filter 6. Thus, FIGS. 4-7 show four different embodiments. The circumference of the filter 6 in the area of the surface of its open base 8 is schematically represented by a circle. Under this circle, the pipe 4 with the openings 3 is located. The drawing also shows three adjoining broken-line circles, the central points of which are marked by dash-dotted crosses. In FIG. 4, the pipe 1 has three openings 3 that are disposed at an angle relative to the longitudinal direction 4 of the pipe 1 (and thus relative to the direction of flow L) and at an angle relative to the central axis 7 of the filter 6 so that in the areas of the dash-dotted crosses, the compressed gas exiting in a series of on and off pulses from the openings 3 impinges the open base 8 of the filter 6. Because the flow profile widens in the form of a cone from the opening 3 to the base 8 of the filter 6, the compressed air exiting in a series of on and off pulses from the openings 3 is applied to the areas enclosed by the dash-dotted circles. As already illustrated in FIG. 4 with only three openings, these areas cover a major portion of the base area 8 of the filter 6 and thereby ensure that the cleaning gas enters the inside of the filter 6 as homogeneously as possible, which in turn leads to excellent cleaning of the textile fabric or nonwoven material lining the lateral surface of the filter 6.

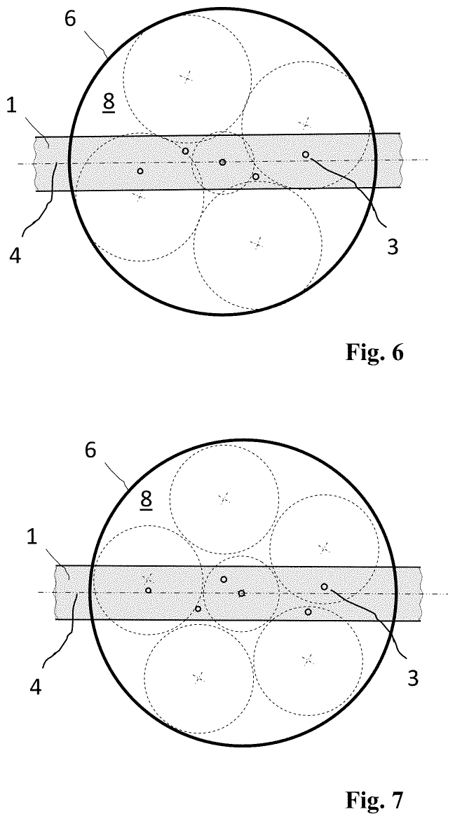

In FIG. 5, the same situation is shown with four openings and four adjoining dash-dotted circles, in FIG. 6 with five openings, with the opening in the center having a smaller diameter than the two laterally adjoining openings to the left and right in the wall of the pipe 1 so that the circle in the center has a smaller diameter and fits among the four circles having the larger diameter that enclose it. A similar situation exists in the configuration with six openings shown in FIG. 7.

As the sequence of FIGS. 4-7 indicates, a larger number of openings 3 in the wall of the pipe 1 has the effect that in the plane of the base 8 of the filter 6, the cross-section, to which compressed air is applied, is larger, which thus also leads to more thorough cleaning. On the other hand, if the number of openings 3 is too large, the cleaning efficiency will decrease, and thus the optimum number of openings is between three and nine.

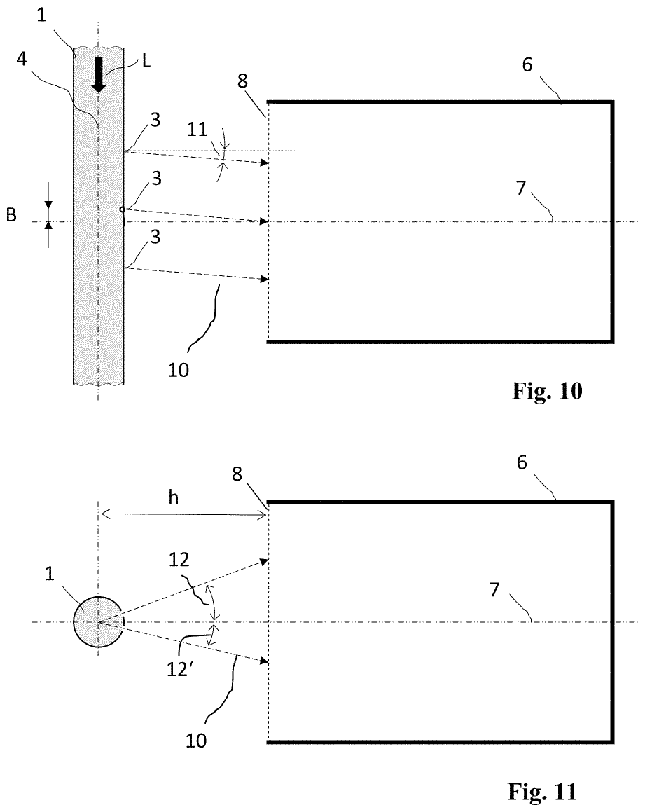

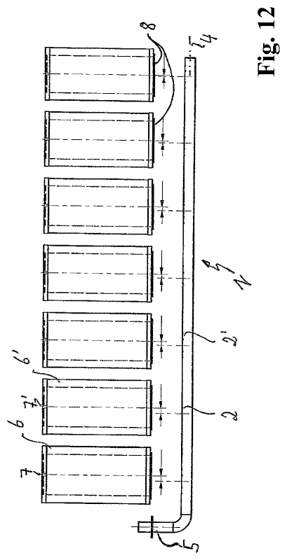

In an especially preferred practical example that is shown in FIGS. 10 to 12, the distance B between the central axes 7 of successive filters 6 and the central point of each group 2 and 2′ of the openings 3 is not constant. Instead, this distance B, B′, B″ decreases in the direction of flow L in order to take into account the fact that the velocity of the gas inside the pipe 1 decreases. As this velocity decreases, the gas exits the openings 3 of the pipe 1 at an increasingly more vertical angle so that the distance B between the central axes 7 of the filters 6 and the central point of the group 2 and 2′ decreases in order to achieve a uniform application of compressed air to all floors 8 of the filters 6. In the figures, the filters to be cleaned are identified by the reference characters 6, 6′, etc. The filters involved are cylindrical filters 6 with central axes 7 and 7′. As the figures indicate, the distances B and B′, B″ decrease, as seen when looking from the point of application 5 of compressed air to the pipe 1. In the last of the seven filters 6 illustrated in FIG. 12, the center of the group 2 of openings 3 is in near alignment with the respective central axis 7 of this last filter 6. This allows a drop in the velocity inside the pipe 1 to be compensated for because the relative position between the respective group 2 of openings 3 and the central axis 7 and 7′ of the cylindrical filter 6 and 6′ to be cleaned changes.

FIG. 11 shows the configuration of FIG. 10 after a 90° rotation about the central axis 7, i.e., in the direction of flow L of the pipe 1. The center of the pipe 1 is at a distance h from the base 8 of the filter 6, exactly as shown in FIG. 10. The angles 12 and 12′ show the distance between the openings 3 farthest apart from each other at right angles relative to the direction of flow L along the circumference of the pipe 1. The different angles 12 and 12′ result from the necessity to achieve one of the patterns of application of compressed air to the base 8 of the filter 6 shown in FIGS. 4-7.

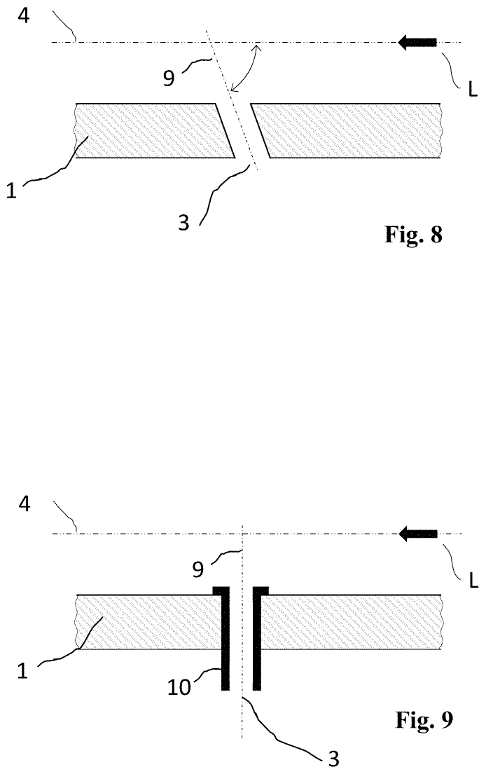

According to a different embodiment shown in FIG. 8 in the form of a magnified section through the wall of the pipe 1, the individual openings 3 of each group 2 have a bore axis 9 (i.e., their central axis) that is disposed at an angle of less than 90°, i.e., at an acute angle, relative to both the central axis 7 of the filter 6 and the longitudinal direction 4 of the pipe 1. This means that the openings 3 run at an oblique slope relative to the wall of the pipe 1 and the longitudinal direction 4 thereof. The oblique slope is implemented, for example, by means of an oblique bore.

This oblique slope of the bore axis 9 of each opening 3 is directed opposite to the direction of flow L so that, assuming that the correct angle of bore is used, the gas exiting from the openings 3 is ultimately deflected at a right angle from its direction of flow L through the pipe 1 when it passes through the openings 3. It is, however, also possible for the central axes 9 of the openings 3 to run at an oblique slope in a plane extending at right angles relative to the longitudinal direction 4 of the pipe 1 so that the air flowing through, relative to its original direction of flow along the longitudinal direction 4 of the pipe, is not only pushed out of the pipe 4 sic but is also laterally deflected.

In yet another modification of the present disclosure illustrated in FIG. 9, the openings 3 of each group 2 may comprise an additionally incorporated pipe-like structure 10 that may be, for example, a sleeve having a stop. These pipe-like structures 10 are preferably fixedly connected to the wall of the pipe 1 in order to prevent these component parts from being dislodged under high compressive stress. This pipe-like structure allows the air to be more targetedly directed in its exiting direction.

The openings 3 preferably have a diameter between 4 and 20 mm, but more preferably between 8 and 16 mm.

With respect to the configuration of the openings 3 within the group 2 and/or the incline of the central axes 9 of at least one opening 3 relative to the longitudinal direction 4 of the pipe 1, the different groups 2 of the openings 3 may have a different layout, i.e., not every group 2, 2′ and 2″ has to have the same layout.

The filters 6 comprise a cylinder made of a filter material, which cylinder may be closed off against the open base 8 (not shown) by means of a filter material as well. The cylinders 6 and 6′ are open toward the clean side (in FIG. 11 at the bottom). On this side, the pipe 1 of the perforated pipe nozzle with the groups 2 of openings 3 is disposed. Each group 2 of openings 3 is dedicated to the open inlet area or base 8 of a filter 6, thereby allowing the air exiting in a series of on and off pulses through the openings 3 to reach the inside chamber of each filter 6 where it can flow through the filter material, which causes the contaminants adhering to the outside of the filter (in FIG. 11 at the top), i.e., to the dirty side of the filters 6, to be dislodged and to drop off.

The number of openings 3 and the constant number within each group 2 ensures that the pressure that has been built up in a series of on and off pulses in the inlet region of each cylindrical filter 6 remains constant across the entire area so that it is not possible for a counterflow out of the filter to be cleaned to be generated. The more openings 3 there are in each group 2, the easier it is to build up a constant pressure in the inlet region of the filter 6. However, it takes only three openings 3 to maintain this pressure constant in the inlet region of the filter 6. An especially favorable embodiment provides for five openings, the configuration of which in the pipe 1 does not exactly follow the pattern of spots on the side of a die marked with the number five, however, but is warped instead, as illustrated in FIG. 3.

Experiments have demonstrated that the actual flow pattern in the region of the inlet of the filters to be cleaned is not consistent with the pattern of the openings in the wall of the pipe because the individual air jets, such they as exit from each opening, attract each other due to the developing low pressure. Thus, an asymmetric configuration of the openings 3 in each group 2, 2′ and 2″ ultimately leads to a symmetric distribution of pressure, with a constant pressure across the entire base 8 of the cylindrical or conical filter 6 to be cleaned.

1. A filter configuration for gaseous media, comprising a plurality of structurally identical cylindrical filters, each of the plurality of filters having a central axis and an open base, and a pipe disposed opposite to the open bases of the filters and comprising a group of lateral openings dedicated to each filter, through which piped gas can flow in a direction of flow, wherein each group comprises a minimum of three openings and wherein the distance between the openings of each group farthest apart from each other in the direction of flow measures at least three times the distance between the openings of each group farthest apart from each other at right angles relative to the direction of flow, as measured around the circumference of the pipe.

2. The filter configuration of claim 1, wherein an extension of each group along the pipe covers at least 40% of a diameter of the dedicated filter.

3. The filter configuration of claim 1, wherein the sum of the cross-sectional areas of all openings within each group has the same value with a tolerance of plus or minus 20%.

4. The filter configuration of claim 1, wherein each group has the same number of openings, with the possible exception of one opening.

5. The filter configuration of claim 1, wherein the number of openings of each group is between three and nine.

6. The filter configuration of claim 5, wherein the number of openings of each group is five or six.

7. The filter configuration of claim 1, wherein the openings have a diameter between 4 mm and 20 mm.

8. The filter configuration of claim 1, wherein the openings have a diameter between 8 mm and 16 mm.

9. The filter configuration of claim 1, wherein the central point of each group of openings is at a distance from the central axis of the filter dedicated thereto, with the openings of the groups, in relation to the central axis of the filter dedicated thereto, being disposed upstream.

10. The filter configuration of claim 9, wherein in each group of openings, the distance from the entry of the compressed air into the pipe decreases in the direction of flow.

11. The filter configuration of claim 1, wherein the openings have a circular or oval shape.

12. The filter configuration of claim 1, wherein at least one opening of each group comprises an additionally incorporated pipe-like structure.

13. The filter configuration of claim 1, wherein, with respect to the configuration of the openings within the group and/or the angle of their axes of flow, the different groups of openings have a different layout.

14. The filter configuration of claim 1, wherein each opening has an axis of flow extending in the center thereof, and at least one axis of flow of an opening forms an acute angle relative to the central axis of the dedicated filter.

15. The filter configuration of claim 14, wherein one other axis of flow of at least one other opening of the same group forms another angle relative to the central axis of the dedicated filter, which angle differs from the acute angle of the first opening.

16. The filter configuration of claim 15, wherein other axes of flow of other openings of the same group form other different acute angles relative to the central axis of the dedicated filter.
